(19) United States
(12) Patent Application Publication
(10) Pub. No.: US 2011/0312858 A1
(43) Pub. Date: Dec. 22, 2011

(54) COMPOSITION AND METHODS FOR OILFIELD APPLICATION

(76) Inventor: Jonathan W. Holt, Centennial, CO (US)

(21) Appl. No.: 12/819,718

(22) Filed: Jun. 21, 2010

(51) Int. Cl. C09K 8/42; C09K 8/00

(52) U.S. Cl. 507/202; 507/200; 507/269; 507/273; 507/219; 507/225

(57) ABSTRACT

The invention provides a method made of steps of providing a composition comprising a first chemical component and a degradable protective layer, wherein the degradable protective layer is at least partially degradable when subject to temperature, pH or time; and introducing into a wellbore the composition and allowing the degradable protective layer to degrade and release the first chemical component.

### FIELD OF THE INVENTION

This invention relates generally to the art of using glass bead for oilfield treatment. More particularly it relates to liquid chemicals being encapsulated in glass bead and methods of using such glass beads in a well from which oil and/or gas can be produced.

### BACKGROUND

The statements in this section merely provide background information related to the present disclosure and may not constitute prior art.

Hydrocarbons (oil, natural gas, etc.) are obtained from a subterranean geologic formation (i.e., a reservoir) by drilling a well that penetrates the hydrocarbon-bearing formation. During the construction of underground wells, it is common, during and after drilling, to place a liner or casing, which is then secured by a settable material that is pumped into the annulus around the outside of the casing. In the industry, this practice is often referred to as “well cementing,” although the material that is used for this purpose is not limited to cement. The settable material serves to support the casing; i.e. to “cement” it in place; and to isolate the various fluid-producing zones through which the well passes. This later function is important since it prevents fluids from different layers communicating with each other. For example, the settable material prevents formation fluids from entering the water table and polluting drinking water, or prevents fluids from one formation from flowing into another. In order to fulfill this function, the settable material must be a continuous sheath that does not allow any leak paths through or around it. After placement, this sheath can deteriorate over time and flow paths can be created through the material or at the interface between the material and the formation or the interface between the casing and the material. The deterioration can be due to physical stresses caused by pressure or temperature effects, chemical degradation of the cement, or various other reasons. These stresses may be caused due to changes originating in the well or surrounding formation, or due to changes in conditions at surface that have an impact on downhole environment. Some attempts to ensure further isolation of the sheath were sought, however a need still exist on a way to provide said isolation.

At the time, the well is drilled and cemented, a partial flowpath for the hydrocarbon to reach the surface is done. In order for the hydrocarbon to be produced, that is travel from the formation to the wellbore (and ultimately to the surface), there must be a sufficiently unimpeded flowpath from the formation to the wellbore. This flowpath is through the formation rock—e.g., sandstone, carbonates—which has pores of sufficient size, connectivity, and number to provide a conduit for the hydrocarbon to move through the formation. Usually, a stimulation stage is needed for increasing the flow of hydrocarbons coming from the subterranean reservoir.

Hydraulic fracturing involves injecting fluids into a formation at high pressures and rates such that the reservoir rock fails and forms a fracture (or fracture network). Proppants are typically injected in fracturing fluids after the pad to hold the fracture(s) open after the pressures are released. In chemical (acid) stimulation treatments, flow capacity is improved by dissolving materials in the formation.

In hydraulic and acid fracturing, a first, viscous fluid called a “pad” is typically injected into the formation to initiate and propagate the fracture. This is followed by a second fluid that contains proppant to keep the fracture open after the pumping pressure is released. Granular proppant materials may include sand, ceramic beads, or other materials. In “acid” fracturing, the second fluid contains an acid or other chemical such as a chelating agent that can dissolve part of the rock, causing irregular etching of the fracture face and removal of some of the mineral matter, resulting in the fracture not completely closing when the pumping is stopped. Occasionally, hydraulic fracturing is done without a highly viscosified fluid (i.e., slick water) to minimize the damage caused by polymers or the cost of other viscosifiers. When hydraulic fracturing fluids and further treatment fluids are used downhole, usually there is a need to provide chemicals downhole in a reliable manner.

It is a purpose to describe herewith an encapsulation manner using glass bead usable in various stages of the completion/production of a well: drilling, cementing, stimulation.

### SUMMARY

In a first aspect, a method is disclosed. The method comprises the step of providing a composition comprising a first chemical component and a degradable protective layer, wherein the degradable protective layer is at least partially degradable when subject to temperature, pH or time; and introducing into a wellbore the composition and allowing the degradable protective layer to degrade and release the first chemical component.

In a second aspect, a method of treating a subterranean formation from a wellbore is disclosed. The method comprises the step of providing a composition comprising a first chemical component and a degradable protective layer, wherein the degradable protective layer is at least partially degradable when subject to temperature, pH or time; introducing into a wellbore the composition; contacting the composition with the subterranean formation and allowing the degradable protective layer to degrade.

In a third aspect, a method of cementing a wellbore is disclosed. The method comprises providing a cement comprising a first chemical component and a degradable protective layer, wherein the degradable protective layer is at least partially degradable when subject to temperature, pH or time; introducing into the wellbore the cement; allowing the degradable protective layer to degrade and release the first chemical component in the cement.

### BRIEF DESCRIPTION OF THE DRAWINGS

FIG. 1 is a schematic view of the glass bead.

FIG. 2 is a schematic view of the use of the glass bead in one embodiment.

FIG. 3 is a schematic view of the use of the glass bead in a second embodiment.

FIG. 4 is a schematic view of the use of the glass bead in a third embodiment.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

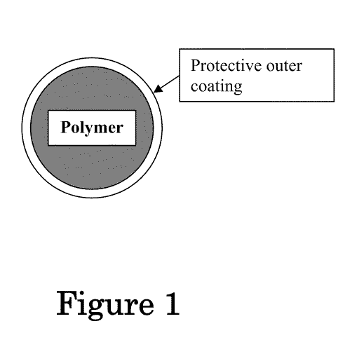

According to an embodiment, an encapsulation system is proposed comprising protective degradable outer coating or layer made of glass able to encapsulate a chemical component inside (FIG. 1). The glass is characterized by being able to be degraded over time due to external parameters of the well. At the difference of over prior arts systems as for example disclosed in U.S. Pat. No. 4,506,734 the glass is not totally inert, i.e. in those systems a mechanical stress has to be applied on the glass bead to release the chemical component. The current system can release the chemical component if subject to mechanical stress, however primarily purpose of the protective layer is to be degraded over time not necessarily with strong mechanical stimuli. The outer layer is made of glass which ionically disassociates at a tailored rate with time, temperature, and pH used as rate controllers. In one embodiment, the coating is composed of borosilicates and other inorganic materials.

The glass beads containing the chemical component have preferably sufficient ductility to prevent their breakage when (a) passing through surface pumps and blending equipment commonly utilized in drilling, cementing or hydraulic fracturing treatments and (b) being introduced into the wellbore and out into the formation. Also, the beads preferably are capable of withstanding the hydrostatic pressure within the formation without significant or any breakage. Such hydrostatic pressures encountered can be from about 1000 psi upwards to above about 10,000 psi. Also, a small hole can be provided in each of the beads to permit some fluid entry into each bead to equalize the pressures within and without. The hole size is preferably small enough to prevent any significant leakage of the breaker chemical from having a deleterious effect on the overall treatment. The beads are designed so that when surrounded by hydrostatic fluid pressure (equal on all sides) they will not break.

The beads can be formed in either round, square, or irregular configurations. They may vary in diameter from a few microns (e.g., 5 microns or possibly 10 microns) up to approximately 100 microns, or 150 microns or even 300 microns. Generally, however, the diameter will not be greater than approximately 200 microns.

The exterior glass wall thickness for beads also varies, usually from a fraction of a micron up to approximately 10% of the diameter of a complete glass bead. However, beads having exterior glass wall thicknesses as high as 20% of their diameter may sometimes be useful in applications where extremely high strength with some sacrifice in lightness of weight is possible. Exterior wall thicknesses from a fraction of a micron (e.g., 0.5 micron) up to approximately 5 or 7% of bead diameter are most frequently preferred for applications taking advantage of high resistance to isostatic crushing in combination with low weight and density as compared to other known glass bubbles.

According to another embodiment, the bead can comprise two or more chambers able to content respectively two or more chemical components. According to such embodiment a way to encapsulate multiple chemical components is possible.

According to one embodiment, the chemical component is a crosslinkable polymer. Typically, the crosslinkable polymer is water soluble. Common classes of water soluble crosslinkable polymers include polyvinyl polymers, polymethacrylamides, cellulose ethers, polysaccharides, lignosulfonates, ammonium salts thereof, alkali metal salts thereof, as well as alkaline earth salts of lignosulfonates. Specific examples of typical water soluble polymers are acrylamide polymers and copolymers, acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyvinyl pyrrolidone, polyalkyleneoxides, carboxycelluloses, carboxyalkylhydroxyethyl celluloses, hydroxyethylcellulose, galactomannans (e.g., guar gum), substituted galactomannans (e.g., hydroxypropyl guar), heteropolysaccharides obtained by the fermentation of starch-derived sugar (e.g., xanthan gum), and ammonium and alkali metal salts thereof. Other water soluble crosslinkable polymers include hydroxypropyl guar, partially hydrolyzed polyacrylamides, xanthan gum, diutan gum, polyvinyl alcohol, and the ammonium and alkali metal salts thereof.

The crosslinkable polymer is available in several forms such as a water solution or broth, a gel log solution, a dried powder, and a hydrocarbon emulsion or dispersion. The encapsulated crosslinkable polymer will be in liquid or gel form.

According to a second embodiment, the chemical component is a crosslinking agent. The second embodiment can be used in combination with the first or independently. The crosslinking agents are organic and inorganic compounds well known to those skilled in the art. Exemplary organic crosslinking agents include, but are not limited to, aldehydes, dialdehydes, phenols, substituted phenols, hexamethylenetetramine and ethers. Phenol, phenyl acetate, resorcinol, glutaraldehyde, catechol, hydroquinone, gallic acid, pyrogallol, phloroglucinol, formaldehyde, and divinylether are some of the more typical organic crosslinking agents. Typical inorganic crosslinking agents are polyvalent metals, chelated polyvalent metals, and compounds capable of yielding polyvalent metals. Some of the more common inorganic crosslinking agents include chromium salts, aluminates, gallates, dichromates, titanium chelates, aluminum citrate, chromium citrate, chromium acetate, and chromium propionate.

According to a further embodiment, the encapsulation can be used for additives as breakers, anti-oxidants, corrosion inhibitors, delay agents, biocides, buffers, fluid loss additives, pH control agents, solid acids, solid acid precursors, organic scale inhibitors, inorganic scale inhibitors, demulsifying agents, paraffin inhibitors, corrosion inhibitors, gas hydrate inhibitors, asphaltene treating chemicals, foaming agents, fluid loss agents, water blocking agents, EOR enhancing agents, or the like. The additive may also be a biological agent.

The beads may be used, for example in oilfield treatments. The beads may also be used in other industries, such as in household and industrial cleaners, agricultural chemicals, personal hygiene products, cosmetics, pharmaceuticals, printing and in other fields.

Also, in some embodiments, the beads may be used in treating a portion of a subterranean formation. In certain embodiments, the beads may be introduced into a well bore that penetrates the subterranean formation. Optionally, the beads further may comprise particulates and other additives suitable for treating the subterranean formation. For example, the beads may be allowed to contact the subterranean formation for a period of time sufficient to release the chemistry. In some embodiments, the beads may be allowed to contact hydrocarbons, formations fluids, and/or subsequently injected treatment fluids. After a chosen time, the beads may release the chemistry in the wellbore.

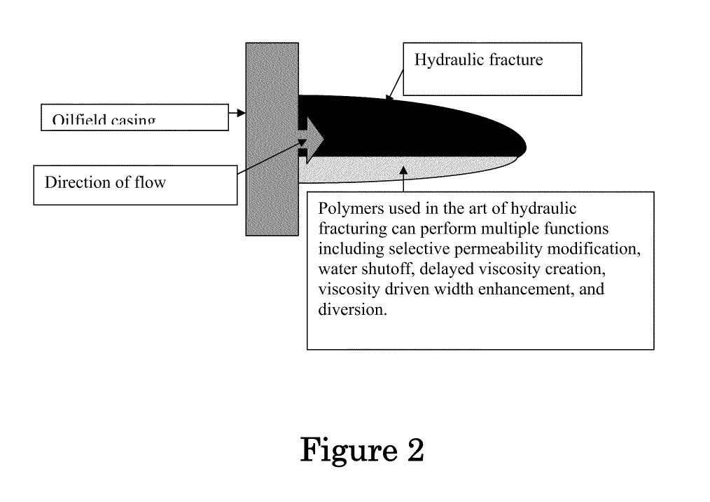

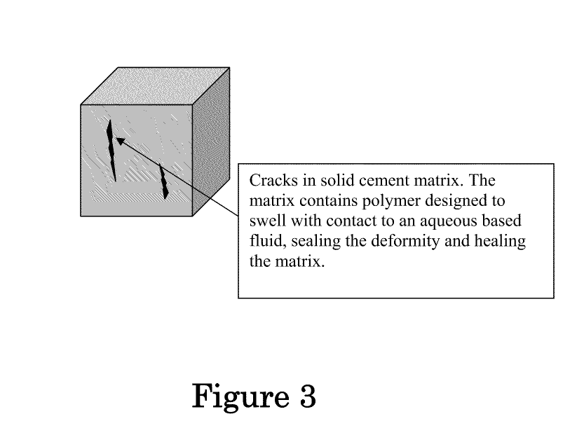

The beads may be used for carrying out a variety of subterranean treatments, where encapsulation may be used, including, but not limited to, drilling operations, cementing operations, fracturing treatments, and completion operations (e.g., gravel packing). In hydraulic fracturing (FIGS. 2 & 4), the beads may be used for viscosification, cross-linking, friction reduction, proppant suspension or transport, selective relative permeability modification (RPM), water control, time delayed dilatant fluid effect, water flooding. In oilwell cementing (FIG. 3), the beads may be used for fluid loss control, viscosification, density extension beyond API density, retardation, self-healing cements, flexibility enhancement, expansion. In drilling, the beads may be used for fluid viscosification, lubrication, solid suspension and/or removal, zone isolation either temporary or permanent.

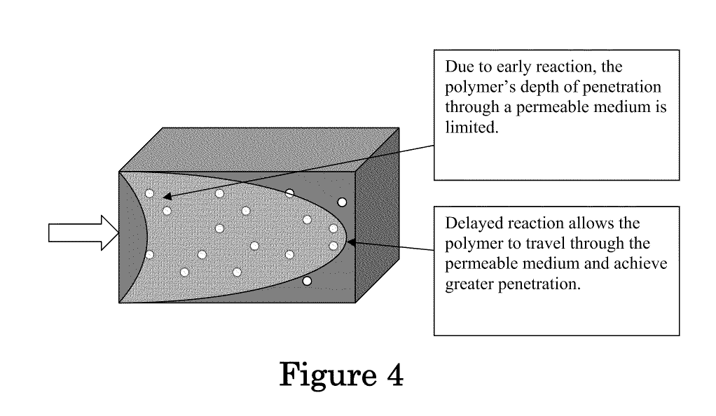

The encapsulation uses a coating surrounding the polymer to delay reaction for ease and/or improvement in placement, application, injection, mixing, or pumping. Under designed conditions or solution, the coating dissolves, cracks, breaks, and/or disassociates to expose the polymer to reaction and the purpose of operation. Higher concentrations of polymer to be added to the mixture without increasing mixing difficulty by maintaining a reasonable viscosity is allowed. The depth of polymer penetration into geological formations via matrix permeability, induced hydraulic fractures, and natural fractures through maintaining the original solution mixture, later releasing the polymer for reaction and enhancing viscosity induced fracturing and width is possible (FIG. 4). The viscosity related friction losses during pumping is reduced.

According to a further aspect, a method of treating a well is disclosed. In one embodiment polyacrylimide (water swelling polymer) is encapsulated. The method can be used for complexity generation of a diverting agent in stimulation. The method can be used in placement of cement to keep polymer from reacting until after placement. The method can be used for water control by aiding high concentration placement. The method can be used for mud removal by increasing downhole viscosity without surface mixing issues.

According to a further aspect, other methods are disclosed. For example, breaker coating by time released, accelerator for rapid sets by coated salt or other accelerator, crosslinkers by time delayed for medium to high temperature (known dissolution at 175 degF, but can be controlled with pH and ionic solutions), for drilling fluid polymers with more linear viscosity profile with temperature for even ECD distribution, for use as insulating material behind casing for offshore applications where casing buckling/burst are issues and placement of N₂ is difficult, for use as solid foam cement where N₂ is present in even distribution after placement.

The beads are also suitable for gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of “proppant” (natural or synthetic materials that prop open a fracture after it is created) in hydraulic fracturing or “gravel” in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Gravel is also a natural or synthetic material, which may be identical to, or different from, proppant. Gravel packing is used for “sand” control. Sand is the name given to any particulate material from the formation, such as clays, that could be carried into production equipment. Gravel packing is a sand-control method used to prevent production of formation sand, in which, for example a steel screen is placed in the wellbore and the surrounding annulus is packed with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations are frequently poorly consolidated, so that sand control is needed; they may also be damaged, so that fracturing is also needed. Therefore, hydraulic fracturing treatments in which short, wide fractures are wanted are often combined in a single continuous (“frac and pack”) operation with gravel packing. For simplicity, in the following we may refer to any one of hydraulic fracturing, fracturing and gravel packing in one operation (frac and pack), or gravel packing, and mean them all.

The particular embodiments disclosed above are illustrative only, as the invention may be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above may be altered or modified and all such variations are considered within the scope of the embodiments described herewith. Accordingly, the protection sought herein is as set forth in the claims below.

1. A method comprising:
a. providing a composition comprising a first chemical component and a degradable protective layer, wherein the degradable protective layer is at least partially degradable when subject to temperature, pH or time;
b. introducing into a wellbore the composition and allowing the degradable protective layer to degrade and release the first chemical component.

2. The method of claim 1, wherein the degradable protective layer is glass.

3. The method of claim 1, wherein the degradable protective layer is made of borosilicate.

4. The method of claim 1, wherein the first chemical component is a gas.

5. The method of claim 1, wherein the first chemical component is a swellable polymer.

6. The method of claim 5, wherein the swellable polymer comprises acrylamide polymer and copolymer.

7. The method of claim 1, wherein the first chemical component is a crosslinkable polymer.

8. The method of claim 7, wherein the crosslinkable polymer comprises acrylamide polymer and copolymer.

9. A method of treating a subterranean formation comprising:
a. providing a composition comprising a first chemical component and a degradable protective layer, wherein the degradable protective layer is at least partially degradable when subject to temperature, pH or time;
b. introducing into a wellbore the composition;
c. contacting the composition with the subterranean formation and allowing the degradable protective layer to degrade and release the first chemical component in the subterranean formation.

10. The method of claim 9, wherein the degradable protective layer is glass.

11. The method of claim 9, wherein the degradable protective layer is made of borosilicate.

12. The method of claim 9, wherein the first chemical component is a gas.

13. The method of claim 12, wherein the gas is carbon dioxide or nitrogen.

14. The method of claim 9, wherein the first chemical component is a swellable polymer.

15. The method of claim 14, wherein the swellable polymer comprises acrylamide polymer and copolymer.

16. The method of claim 9, wherein the first chemical component is a crosslinkable polymer.

17. The method of claim 16, wherein the crosslinkable polymer comprises acrylamide polymer and copolymer.

18. A method of cementing a wellbore comprising:
a. providing a cement comprising a first chemical component and a degradable protective layer, wherein the degradable protective layer is at least partially degradable when subject to temperature, pH or time;
b. introducing into the wellbore the cement;
c. allowing the degradable protective layer to degrade and release the first chemical component in the cement.

19. The method of claim 18, wherein the degradable protective layer is glass.

20. The method of claim 19, wherein the degradable protective layer is made of borosilicate.

21. The method of claim 18, wherein the first chemical component is a swellable polymer.

22. The method of claim 21, wherein the swellable polymer comprises acrylamide polymer and copolymer.
